(19) United States
(12) Patent Application Publication
(10) Pub. No.: US 2002/0000104 A1
(43) Pub. Date: Jan. 3, 2002

(54) Methods of making preform and optical fiber

(75) Inventors: Hideyuki Ijiri, Kanagawa (JP); Kouichi Uchiyama, Kanagawa (JP); Toshio Danzuka, Kanagawa (JP); Tomonori Kashiwada, Kanagawa (JP)

Correspondence Address: McDERMOTT, WII & EMERY, 600 13th Street, N.W., Washington, DC, 20005-3096, US

(73) Assignee: Sumitomo Electric Industries, Ltd., Osaka (JP)

(21) Appl. No.: 09/843,838

(22) Filed: Apr. 30, 2001

Related U.S. Application Data
(63) Continuation-in-part of application No. PCT/JP99/06046, filed on Oct. 29, 1999.

(30) Foreign Application Priority Data
Oct. 29, 1998 (JP) P1998-308678

(51) Int. Cl. C03B 37/10

(52) U.S. Cl. 65/428

(57) ABSTRACT

The present invention relates to a method of making a preform which can restrain each member from deforming at the time of making, and a method of making an optical fiber with a smaller polarization mode dispersion by utilizing this preform. In the method of making a preform, the collapsing step carried out when making the preform is divided into at least two stages composed of a first step of forming a first collapsed body by collapsing a core rod member and a first cladding tube member, and a second step of forming a new collapsed body by collapsing the first collapsed body and a second cladding tube member. Also, in at least the first step, the collapsed body obtained is elongated, whereas such a plurality of stages of collapsing step and elongation of the resulting collapsed body reduce the outer diameter ratio of the outer member to the inner member to be collapsed, whereby the deformation resulting from the heating at the time of a single collapsing operation and the like is hard to occur. In an optical fiber obtained from thus manufactured preform, the core and cladding are effectively restrained from becoming noncircular, whereby the polarization mode dispersion characteristic, which becomes important in communications based on a WDM system, is improved in particular.

### RELATED APPLICATIONS

This is a Continuation-In-Part application of International Patent application serial No. PCT/JP99/06046 filed on Oct. 29, 1999, now pending.

### BACKGROUND OF THE INVENTION

1. Field of the Invention

The present invention relates to a method of making a preform by rod-in-collapse method, and a method of making an optical fiber by utilizing this preform.

2. Related Background Art

In optical transmissions with a single-mode optical fiber, a dispersion (chromatic dispersion) represented by the sum of a material dispersion (dispersion caused by the wavelength dependence of refractive index inherent in the material of optical fiber) and a structural dispersion (dispersion caused by the wavelength dependence of group velocity of a propagation mode) inevitably occurs. This dispersion is a phenomenon in which an optical pulse having a constant spectrum width deforms upon propagating through a single-mode optical fiber which is a transmission medium. For suppressing the deterioration of transmission quality due to the occurrence of such a dispersion, dispersion-compensating fibers are used in general (e.g., Japanese Patent Application Laid-Open No. HEI 9-127354).

Such a dispersion-compensating fiber has a negative dispersion in a 1.55-μm wavelength band with a large absolute value of dispersion, thereby compensating for the dispersion of the single-mode optical fiber with a high degree of efficiency. Therefore, the dispersion-compensating fiber has such a structural characteristic that it has a greater relative refractive index difference between the core and cladding and a smaller core diameter as compared with the single-mode optical fiber and the like. For example, while the relative refractive index difference between the core and cladding is about 0.35% in typical single-mode optical fibers, that in dispersion-compensating fibers is set to about 2.5% to 3.0%. Also, while the core diameter is about 8 to 10 μm in typical single-mode optical fibers, that in dispersion-compensating fibers is set to about 2 to 3μm.

Known as a method of making an optical fiber such as the dispersion-compensating fiber mentioned above is rod-in-collapse method (rod-in-tube method) in which a rod is inserted in a tube, and they are fused together by heating, so as to make an optical fiber preform (e.g., Japanese Patent Application Laid-Open No. SHO 60-33225). This method is excellent in manufacturing efficiency, yield, and the like.

### SUMMARY OF THE INVENTION

The inventors have studied the prior art mentioned above, and have found out the following problems. Namely, when making a preform for a dispersion-compensating fiber having the above-mentioned structure by rod-in-collapse method, a core rod having an outer diameter smaller than that of a core rod for yielding a typical single-mode optical fiber having a zero-dispersion wavelength in a 1.3-μm wavelength band must be prepared. Also, it is necessary to raise the dopant concentration of germanium or the like in this core rod in order to increase the relative refractive index difference between the core and cladding.

Core rod containing a large amount of impurities exhibit a low glass viscosity, and the outer diameter is small in particular in core rods for dispersion-compensating fibers. Therefore, the core rods are likely to deform (become noncircular) upon heating at the time of collapsing, and bubbles and the like are likely to remain in the resulting collapsed bodies. While collapsing is carried out by heating a tube containing a core rod from the outer periphery of the tube, it is necessary to raise the heating temperature for collapsing in the case where the tube is thicker (the outer diameter ratio of the tube to the core rod is greater). When the heating temperature is higher, the outer peripheral portion of the tube is more likely to deform, whereby noncircular deformations may occur due to minute temperature changes in the circumferential direction and the like.

In optical fibers employed in wavelength division multiplexing (WDM) type optical communications in which signal light components having wavelengths different from each other are multiplexed in order to yield a larger transmission capacity, in particular, it is important to suppress polarization mode dispersion (PMD) to a small value. The value of polarization mode dispersion increases when ellipticity, which is the deviation of the cross-sectional form of a core or cladding from a perfect circle, is greater. Therefore, in order to lower the value of polarization mode dispersion, optical fibers employed in WDM optical communications are required to have a structure closer to a perfect circle by which cores and claddings are restrained from deforming when making the optical fibers.

For solving problems such as those mentioned above, it is an object of the present invention to provide a method of making a preform whose ellipticity caused by deformations of cores and claddings and the like is smaller, and a method of making an optical fiber such as a dispersion-compensating fiber by utilizing this preform.

The present invention enables the making of an optical fiber having a smaller ellipticity suitable for a dispersion-compensating fiber having a core of silica type glass doped with at least germanium and a cladding of silica type glass disposed at the outer periphery of the core, and the like.

For achieving the object mentioned above, the method of making a preform according to the present invention comprises a first step of forming a first collapsed body, and a second step of forming an outer periphery of the first collapsed body with a second collapsed body integrated with a glass material layer; wherein a collapsing step is carried out twice or more.

Since a collapsing step in which a rod and a tube are integrated by heating with a heat source is carried out by a plurality of separate operations, the ratio of tube outer diameter to rod outer diameter is lowered in the collapsing carried out in the earlier stage, in particular, in regions greatly influencing the efficiency of optical transmissions, whereby the deformation of core and cladding at the time of making the preform, and its resulting increase in ellipticity and the like are suppressed.

In particular, the above-mentioned first step includes a first collapsing step in which, in a state where a core rod to become a core region is inserted in a first cladding tube to become a part of a cladding region, the core rod and first cladding tube are integrated by heating; and a first elongating step of elongating thus obtained collapsed body until a predetermined outer diameter is attained. A dispersion-compensating fiber or the like is designed such that its core outer diameter is smaller than that of a typical single-mode optical fiber. Therefore, if a core rod having the same outer diameter as that of a core rod for the typical single-mode optical fiber is prepared, a thicker cladding tube having a greater outer diameter will be necessary for yielding a predetermined outer diameter ratio. In this case, the ellipticity inevitably increases upon collapsing. Even when a core rod having an outer diameter smaller than that of a core rod for the typical single-mode optical fiber is prepared, by contrast, it is difficult for the rod to be kept from becoming noncircular since a large amount of impurities such as germanium is added thereto (glass viscosity decreases). Therefore, it is preferred that, at the time when the first collapsing step is completed, the outer diameter of the collapsed body (before elongation) obtained by the first collapsing step be 4.5 times or more but 6.5 times or less that of the core rod. If the outer diameter of the collapsed body is 4.5 times or more that of the core rod, then an outer diameter ratio for yielding an optical fiber with a smaller ellipticity can be secured in the subsequent collapsing step. If the outer diameter of the collapsed body is not exceeding 6.5 times that of the core rod, on the other hand, then members can fully be restrained from deforming upon collapsing. Namely, if the outer diameter of the collapsed body is set to 4.5 times or more but 6.5 times or less, preferably 5 times or more but 6 times or less, that of the core rod, then an optical fiber having a particularly favorable polarization mode dispersion characteristic is obtained.

The above-mentioned first step further includes an elongating step (first elongating step) for adjusting the ratio of the tube outer diameter to the rod outer diameter in order to restrain ellipticity from increasing in the subsequent collapsing step. In this elongating step, it is preferred that the collapsed body obtained by the first collapsing step be elongated until the outer diameter after elongation becomes ½ or less of the outer diameter before elongation in order to make it possible to use a tube having a smaller outer diameter in the subsequent collapsing step (to reduce the ratio of the outer diameter of outer member to the outer diameter of inner member).

The first collapsed body is obtained by way of the first collapsing step and elongating step included in the above-mentioned first step.

The above-mentioned second step includes a second collapsing step in which, in a state where the first collapsed body obtained by the first step is inserted in a second cladding tube to become a part of the cladding region, the first collapsed body and the second cladding tube are integrated by heating. Here, the second collapsing step may be repeated a plurality of times, and the second step may include an elongating step (second elongating step) in which the collapsed body obtained by the second collapsing step is elongated until it attains a desirable outer diameter in order to yield a desirable outer diameter ratio. When the collapsing step is repeated, the ellipticity can be expected to further decrease.

At the time when the second collapsing step ends, the second collapsed body obtained preferably has an outer diameter which is 14 times or more that of the core rod. If the outer diameter ratio between the individual members in the second collapsed body is set to such a value, then an optical fiber having a smaller polarization mode dispersion is obtained. Though depending on the outer diameter ratio between the individual members at the time when the first collapsing step ends, its subsequent processing method, and the like, the glass region at the outer periphery of the first collapsed body will be a region fully separated from the core region in the finally obtained optical fiber even if the outer diameter ratio of the second collapsed body to the core rod increases to a certain extent, whereby the influence of ellipticity on optical communications is lower in this region than in the vicinity of the center.

In the method of making a preform according to the present invention, each of the first and second collapsing steps is carried out with one of an electric heater and a flame as a heat source, whereas the flame is obtained by burning one of O₂ and air with a hydrogen fuel (H₂) or burning one of O₂ and air with a hydrocarbon fuel (CH₄, C₃H₈, or the like).

In particular, since the flame caused by burning H₂, O₂, or the like is easy to control, using it as a heat source can enhance the controllability and uniformity of each collapsing step, thereby further restraining the core member and cladding member from deforming. If a flame is utilized as a heat source for the collapsing step or elongating step, however, OH-radical, which causes optical absorption will invade inside from the collapsed body surface obtained. Therefore, when a flame is utilized as a heat source, it is preferred that an etching step of etching a surface of the first collapsed body with an HF solution after the elongating step be carried out at least in the above-mentioned first step. An outer peripheral portion of the first collapsed body is preferably etched to a region whose OH-radical concentration is such that no increase in transmission loss is influenced thereby, whereas a specific thickness to be etched is about 1.0 to 2.5 mm, preferably about 1.4 to 2.3 mm, from the first collapsed body surface. This is because of the fact that such a level enables the OH-radical concentration within the first collapsed body to become 1 ppm or less. In other words, the etching rate with respect to the outer diameter of the first collapsed body is preferably 30% or more in order to remain a transmission loss 3.0 dB/km or less, further preferably 35% or more in order to remain the transmission loss 2.0 dB/km or less.

Also, when a flame is utilized as a heat source in the above-mentioned second collapsing step, it is preferred that a surface of the second collapsed body be etched to a region whose OH-radical concentration becomes 3 ppm or less within the second collapsed body obtained. Etching with an HF solution is described in Japanese Patent Application Laid-Open No. SHO 60-33225, for example.

In the method of making a preform according to the present invention, it is preferred that the first cladding tube prepared in the above-mentioned first step is preferably a member made of silica glass doped with a predetermined amount of fluorine. In the case of a preform for a dispersion-compensating fiber, while a core rod to become a core is doped with germanium (refractive index enhancing agent), a sufficient refractive index difference will be obtained between the core and cladding without increasing the doping amount of germanium in the core of the resulting dispersion-shifted fiber if the first cladding tube to be integrated with the outer periphery of the core rod is doped with fluorine (refractive index lowering agent).

Further, for realizing a depressed cladding structure, the second cladding tube may contain a predetermined amount of fluorine (refractive index lowering agent) or chlorine (refractive index enhancing agent). For example, a dispersion-compensating fiber having a positive dispersion slope will be obtained if a member made of silica glass doped with fluorine by an amount smaller than that in the first cladding tube is employed as the second cladding tube (e.g., Japanese Patent Application Laid-Open No. HEI 10-62641). On the other hand, a dispersion-compensating fiber having a negative dispersion slope will be obtained if a member made of pure silica glass or silica glass doped with a predetermined amount of chlorine is employed as the second cladding tube (e.g., Japanese Patent Application Laid-Open No. HEI 9-127354). Since the collapsing step is carried out a plurality of times as such, the method of making a preform can realize various refractive index profiles by regulating the kind and amount of impurities to be doped for each of the tubes prepared in the respective collapsing steps.

Here, the method of making a preform according to the present invention comprises a glass depositing step of depositing a glass soot body on an outer peripheral surface of the second collapsed body obtained by the second step and sintering the glass soot body so as to form a glass material layer, which is a step carried out after completing the above-mentioned second step in order to attain a sufficient fiber diameter. The glass material layer formed by this glass depositing step is a region corresponding to the jacket layer of the optical fiber obtained, whereas the jacket layer is referred to as a physical cladding in general since it does not contribute to propagating light. By contrast, the inner cladding region, corresponding to the first and second cladding tubes, covered with the glass material layer is referred to as an optical cladding.

The preform obtained by way of the foregoing individual steps, in which each member is restrained from deforming (thus yielding less ellipticity), is utilized in the method of making an optical fiber according to the present invention. In this method, one end of the preform is drawn at a predetermined tension while a part of the preform is being heated. As a consequence, an optical fiber having a lower polarization mode dispersion suitable for WDM optical communications is obtained.

The present invention will be more fully understood from the detailed description given hereinbelow and the accompanying drawings, which are given byway of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1A is a sectional view of an optical fiber obtained by the method of making an optical fiber according to the present invention, whereas FIG. 1B is a refractive index profile of the optical fiber shown in FIG. 1A;

FIGS. 2A to 2C are views for explaining a first step in the method of making a preform according to the present invention;

FIG. 3A is a graph showing the content of OH-radical in the first collapsed body obtained by the first step shown in FIGS. 2A to 2C in a diametrical direction, whereas FIG. 3B is a view for explaining an etching step for eliminating a predetermined thickness of surface layer of the first collapsed body;

FIG. 4 is a graph showing the relationship between the transmission loss (dB/km) at 1.38 μm and the etching rate with respect to the outer diameter of the first collapsed body;

FIGS. 5A and 5B are views for explaining a second step in the method of making a preform according to the present invention;

FIGS. 6A and 6B are views for explaining a glass depositing step for forming a glass material layer at the outer periphery of the second collapsed body obtained by the second step shown in FIGS. 5A and 5B, and illustrate a glass soot body depositing step and a sintering step, respectively;

FIG. 7 is a view showing a drawing apparatus for carrying out a drawing step in the method of making an optical fiber according to the present invention; and

FIG. 8 is a refractive index profile for explaining another example of the optical fiber obtained by the method of making an optical fiber according to the present invention.

### DETAILED DESCRIPTION OF THE PREFERRED EMBODIMENTS

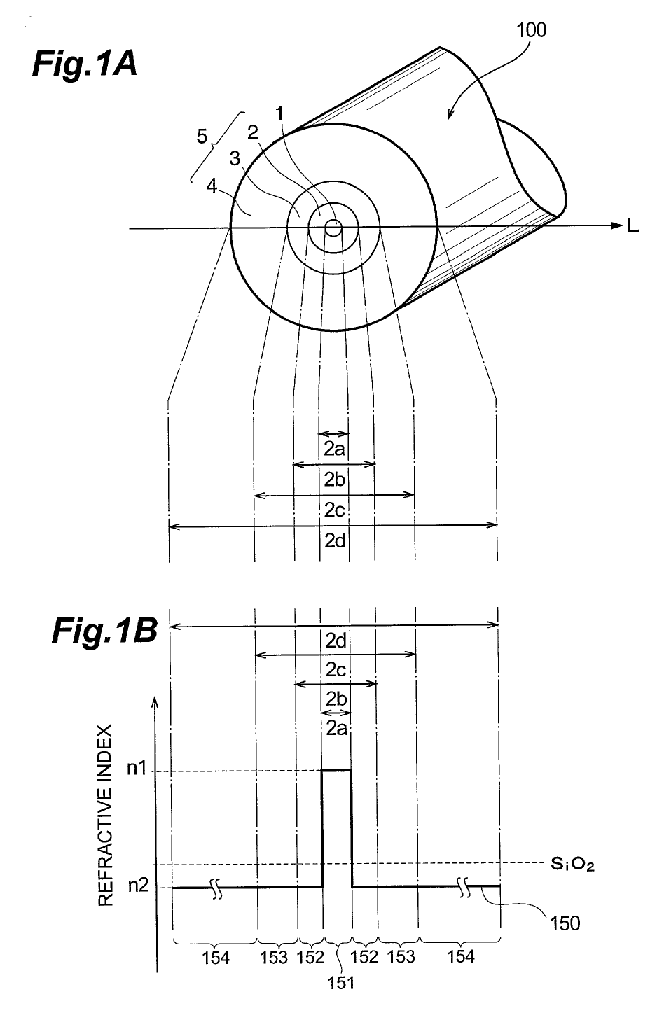

In the following, the method of making a preform and the method of making an optical fiber utilizing this preform according to the present invention will be explained with reference to FIGS. 1A to 3B, 4, 5A to 6B, 7, and 8. In the explanation of the drawings, ratios of dimensions depicted do not always coincide with those explained. In the drawings, parts identical to each other will be referred to with numerals identical to each other without repeating their overlapping explanations.

FIG. 1A shows a cross-sectional structure of an optical fiber obtained by the method of making an optical fiber according to the present invention, whereas FIG. 1B shows the refractive index profile of the optical fiber shown in FIG. 1A. Here, the refractive index profile shown in FIG. 1B is an example of refractive index profiles which can be made, and is modifiable in various manners according to conditions of use of a dispersion-compensating fiber to be obtained, and the like.

In FIG. 1A, an optical fiber 100 comprises a core region 1, extending along a predetermined reference axis, with an outer diameter 2a and a refractive index n₁; and a cladding region 5, disposed at the outer periphery of the core region 1, with a refractive index n₂ (<n₁). Here, the cladding region 5 comprises a first cladding 2, disposed at the outer periphery of the core region 1, having the refractive index n₂ and an outer diameter 2b; a second cladding 3, disposed at the outer periphery of the first cladding, having the refractive index n₂ and an outer diameter 2c; and a jacket layer 4, disposed at the outer periphery of the second cladding 3, having the refractive index n₂ and an outer diameter 2d.

The abscissa of the refractive index profile 150 shown in FIG. 1B corresponds to individual positions along a line L shown in the cross-sectional structure in the drawing on a cross section perpendicular to the center axis of the core region 1, whereas areas 151, 152, 153, and 154 indicate refractive indices on the line L of parts in the core region 1, first cladding 2, second cladding 3, and jacket layer 4, respectively. Here, the core region 1 is doped with a refractive index enhancing agent such as germanium so as to increase the refractive index with reference to the refractive index (indicated by a dotted line in FIG. 1B) of pure silica glass(SiO₂),whereas each of the first cladding 2, second cladding 3, and jacket layer 4 is doped with a refractive index lowering agent such as fluorine.

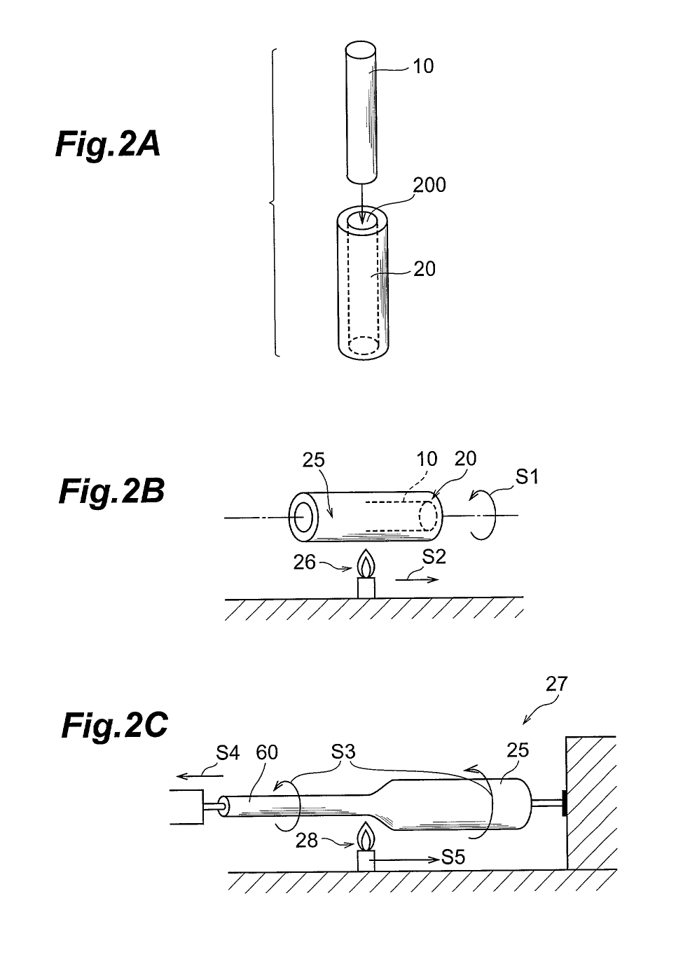

In the following, the method of making a preform in order to obtain an optical fiber having the structure shown in FIGS. 1A and 1B with a lower ellipticity in each glass region will be explained with reference to FIGS. 2A to 6B. While the details of each step will be illustrated specifically according to examples carried out by the inventors, their conditions, such as dopants, outer diameters of individual members, outer diameter ratios between these members, and the like, for instance, are not restricted to the values shown in the following.

### First Step

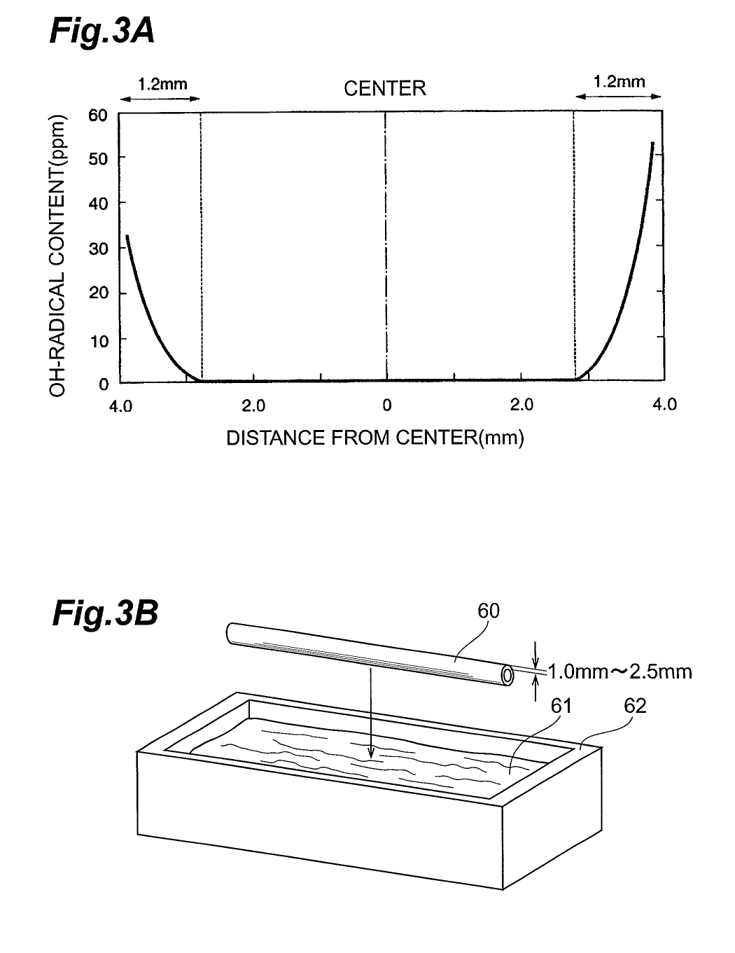

In the first step, a first collapsing step such as the one shown in FIG. 2B, an elongating step such as the one shown in FIG. 2C, and an etching step such as the one shown in FIG. 3B are carried out.

### First Collapsing Step

The first collapsing step is a step in which a core rod 10 and a first cladding tube 20 which have a predetermined outer diameter ratio therebetween are integrated.

The core rod 10 is made as follows. Namely, a glass member is synthesized by VAD (Vapor phase axis deposition) method such that GeO₂ (refractive index enhancing agent) is added thereto so as to yield a relative refractive index difference of Δn=2.5% (=(n₀−n₁)/n₀, where n₀ is the refractive index of pure silica glass, and n₁ is the refractive index of core rod 10), for example, with respect to pure silica glass. Subsequently, thus obtained glass member is dehydrated and sintered. Further, the sintered glass member is elongated by utilizing a heater as a heat source, whereby the core rod member 10 having an outer diameter of about 5 mm is obtained.

As the first cladding tube 20, on the other hand, a tube having an outer diameter of 25 mm and an inside diameter of 5 mm doped with, for example, 0.35% of fluorine as a refractive index lowering agent is prepared. Such a tube is obtained, for example, by successively synthesizing a glass soot body by VAD method or OVD (Outside vapor phase deposition) method, sintering thus synthesized glass soot body in the atmosphere of a fluorine material such as SiF₄ or SF₆, and processing the form of thus obtained glass body. The first cladding tube can also be obtained when a soot body synthesized like a tube is sintered by heating. The soot body can be synthesized by sol-gel method or deposition of fine glass particles as well.

As shown in FIG. 2A, the core rod 10 obtained by way of the manufacturing step mentioned above is inserted into a hole 200 formed in the first cladding tube 20. Subsequently, a first stage of rod-in-collapse is carried out (see FIG. 2B). As preprocessing for insertion into the hole 200 of the first cladding tube member 20, the outer periphery of the core rod 10 is washed. If necessary, processing for shaving the outer periphery of the core rod 10 so as to yield a perfectly circular cross section, and preprocessing for washing the surface layer of the core rod 10 with HF may further be carried out.

In the collapsing after the core rod 10 preprocessed as mentioned above is inserted into the hole 200 of the first cladding tube 20, an H₂/O₂ flame is used as a heat source. Specifically, as shown in FIG. 2B, an H₂/O₂ flame 26 is moved in the direction indicated by depicted arrow S2 while the core rod 10 and the first cladding tube 20 are being rotated in the direction indicated by depicted arrow S1 about the axis of these members, whereby a collapsed body 25 in which the core rod 10 and the first cladding tube 20 are integrated is obtained. Since the H₂/O₂ flame 26 is excellent in controllability, heating (collapsing) with stable flame control is possible. As a consequence, while securing uniformity and isotropy in the integration, each member can be restrained from becoming noncircular (deviating from a perfect circle). In place of H₂, hydrocarbon materials such as CH₄ and C₃H₈, for example, may be used as a fuel for the flame acting as the heat source. Also, air may be utilized in place of O₂. As the heat source, an electric heater or the like may also be utilized instead of the flame mentioned above.

The collapsed body 25 obtained by the foregoing collapsing step has an outer diameter of 23 mm. The outer diameter of the collapsed body 25 is 5.5 times that of the core rod 10, thereby satisfying the condition of 4.5 times or more but 6.5 times or less.

### Elongating Step

The collapsed body 25 obtained by the first collapsing step is elongated to a predetermined outer diameter in order to make it possible to reduce the size of a cladding tube to be prepared in the subsequent collapsing step, thereby lowering the outer diameter ratio of a tube, in which the collapsed body 25 is to be contained, to the collapsed body 25.

In this elongating step (first elongating step), as shown in FIG. 2C, one end of the collapsed body 25 obtained is attached to a securing apparatus so as to be rotatable about the axial direction of the collapsed body 25, whereas the other end of the collapsed body 25 is attached to a moving apparatus so as to be rotatable about the above-mentioned axial direction. The securing apparatus and moving apparatus make the collapsed body 25 rotate in the direction indicated by depicted arrow S3. On the other hand, an H₂/O₂ flame 28 moves in the direction indicated by depicted arrow S5 while heating a part of the collapsed body 25. Since the part of collapsed body 25 heated by the H₂/O₂ flame 28 is softened, a collapsed body 60 (first collapsed body) elongated until the outer diameter becomes ½ or less is obtained when the moving apparatus to which the other end of the collapsed body 25 rotating about the axis is moved to the direction indicated by depicted arrow S4. In this example, the outer diameter of first collapsed body 60 was 7.5 mm.

### Etching Step

In the first collapsing step and elongating step explained in the foregoing, an H₂/O₂ flame is utilized as a heat source. Though excellent in controllability, the H₂/O₂ flame causes OH-radical, which greatly affects transmission loss, to intrude the outer periphery of the tube, which is an outer member, upon heating. FIG. 3A is a graph showing results of measurement of OH-radical content in the diametric direction of the first collapsed body 60 (having an outer diameter of 7.5 mm) obtained. In the first collapsed body 60 obtained by way of the foregoing steps, as can also be seen from this graph, a large amount of OH-radical is contained in the outer peripheral portion having a thickness of about 1.2 mm from the surface.

Since such OH-radical causes transmission loss to increase upon optical absorption, it is preferred that an etching step for eliminating the layer containing the OH-radical intruded therein be carried out as shown in FIG. 3B when a flame is utilized as a heat source.

For verifying the effect of etching, the inventors measured transmission loss at a wavelength of 1.38 μm in optical fibers obtained by utilizing first collapsed bodies 60 etched under various conditions. (a) An optical fiber obtained by utilizing a first collapsed body 60 (having an outer diameter of 5.4 mm) whose outer peripheral portion was etched by a thickness of 0.9 mm yielded a transmission loss of 5.6 dB/km at a wavelength of 1.38 μm. (b) An optical fiber obtained by utilizing a first collapsed body 60 (having an outer diameter of 5.2 mm) whose outer peripheral portion was etched by a thickness of 1.0 mm yielded a transmission loss of 3.7 dB/km at a wavelength of 1.38 μm. (c) An optical fiber obtained by utilizing a first collapsed body 60 (having an outer diameter of 4.4 mm) whose outer peripheral portion was etched by a thickness of 1.4 mm yielded a transmission loss of 1.5 dB/km at a wavelength of 1.38 μm.

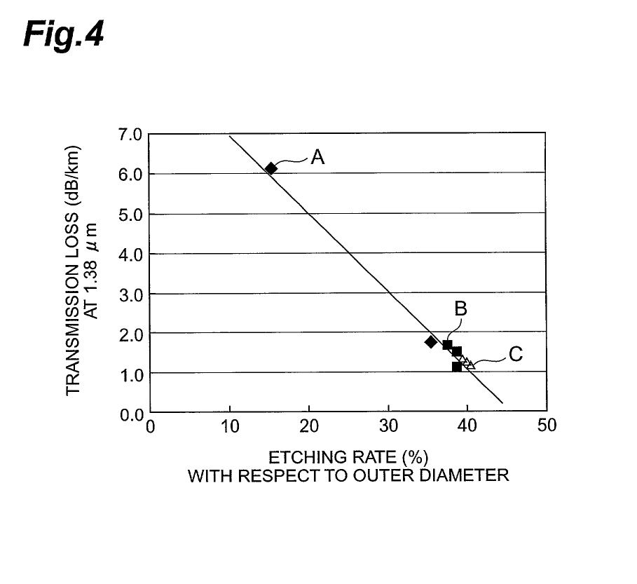

From these results of measurement, it is seen that the transmission loss of the finally obtained optical fiber is ameliorated more as the etching region is thicker. Also, the amount of change in transmission loss with respect to the etched thickness between the above-mentioned cases (a) and (b) is much greater than that between the above-mentioned cases (b) and (c). Further, FIG. 4 is a graph showing the relationship between the etching rate (%) with respect to the outer diameter of the first collapsed body 60. In the figure, symbol A indicates measurement results regarding to samples having a diameter of 8 mm, symbol B indicates measurement results regarding to samples having a diameter of 11 mm, and symbol C indicates measurement results regarding to samples having a diameter of 20 mm. As can be seen from FIG. 4, it is preferable the etching rate is 30% or more in order to keep the transmission loss 3.0 dB/km, and further preferable the etching rate is 35% or more in order to keep the transmission loss a low level of 2.0 dB/km. Therefore, it can also be seen that transmission loss deteriorates drastically as the etching region is thinner. If the etching region is too thick, on the other hand, then it is unfavorable in terms of manufacture in that the outer diameter ratio of the outer member to the inner member to be collapsed may not be obtained sufficiently, smoothness may not be secured in the surface of first collapsed body 60, and so forth. In view of the foregoing, it is desirable that an outer peripheral portion ranging 1.0 to 2.5 mm from the surface of first collapsed body 60 be etched. In the case where an electric heater or the like, for example, is utilized as a heat source, there is no intrusion of OH-radical, whereby this etching step is unnecessary.

In this example, as shown in FIG. 3B, the first collapsed body 60 is dipped in an HF solution 61 (10% to 25%) filling a vessel 62. Of the first collapsed body 60 dipped in the HF solution 61, the outer peripheral portion is etched by a thickness of about 1.0 to 2.5 mm, and the remnant is utilized as the inner member for the subsequent collapsing step. Here, as a consequence of this etching step, the OH-radical concentration within the first collapsed body 60 becomes 1 ppm or less.

### Second Step

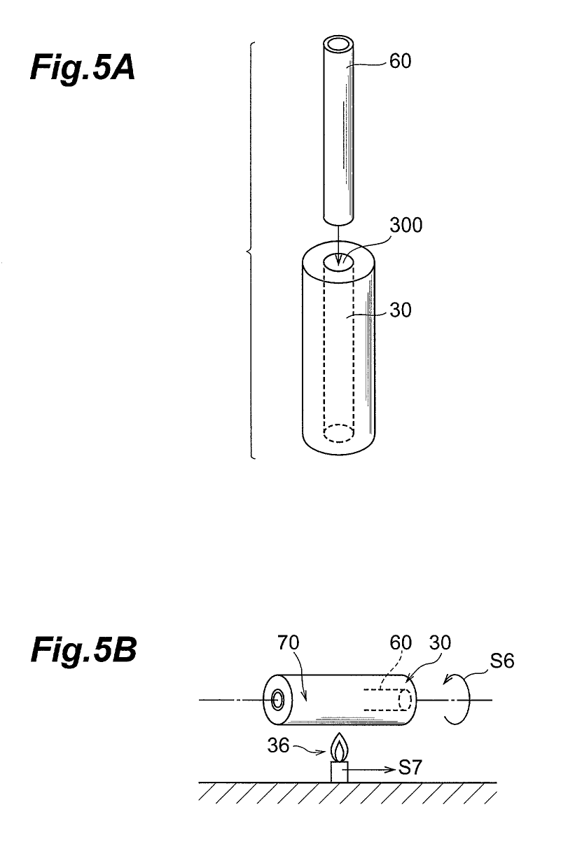

In the second step, at least a second collapsing step such as the one shown in FIGS. 5A and 5B is carried out. This second collapsing step may be carried out a plurality of times. Also, in the second step, an elongating step (second elongating step) similar to the step shown in FIG. 2C and an etching step similar to the step shown in FIG. 3B are carried out if necessary.

A second cladding tube 30 prepared in the second collapsing step may be a tube member manufactured by a method similar to that for the first cladding tube 20 prepared in the above-mentioned first collapsing step, for example. In the second collapsing step, the first collapsed body 60 obtained by the above-mentioned first collapsing step is inserted into a hole 300 formed in the second cladding tube 30 as shown in FIG. 5A, and the first collapsed body 60 and second cladding tube 30 are integrated by an H₂/O₂ flame.

Specifically, as shown in FIG. 5B, an H₂/O₂ flame 36 is moved in the direction indicated by depicted arrow S7 while the first collapsed body 60 and the second cladding tube 30 are being rotated in the direction indicated by depicted arrow S6 about the axis of these members, whereby a collapsed body 70 in which the first collapsed body 60 and the second cladding tube 30 are integrated is obtained. Since the H₂/O₂ flame is excellent in controllability, heating (collapsing) with stable flame control is possible. As a consequence, while securing uniformity and isotropy in the integration, each member can be restrained from becoming noncircular (deviating from a perfect circle). In place of H₂, hydrocarbon materials such as CH₄ and C₃H₈, for example, may be used as a fuel for the flame acting as the heat source. Also, air may be utilized in place of O₂. As the heat source, an electric heater or the like may also be utilized instead of the flame mentioned above.

In the second step, the above-mentioned second collapsing step is carried out at least once, whereby the second collapsed body 70 is obtained. Preferably, the second collapsed body 70 is also subjected to an etching step after the completion of the second collapsing step such that the OH-radical concentration within the second collapsed body 70 becomes 3 ppm or less.

### Third Step (Glass Depositing Step)

The method of making a preform according to the present invention comprises, in addition to the above-mentioned first and second steps, a step of forming a glass region to become a jacket layer of the optical fiber, at the outer periphery of the second collapsed body 70 in order to attain a desirable fiber diameter. Here, the jacket layer refers to a physical cladding, not contributing to propagating light, which is a peripheral region of cladding positioned at the outer periphery of an optical cladding through which light propagates.

The third step comprises an earlier stage of forming a porous glass soot body 75 at the outer periphery of the second collapsed body 70 by a vapor-phase synthesis method such as VAD method or OVD method, for example, and a later stage of sintering the glass soot body 75.

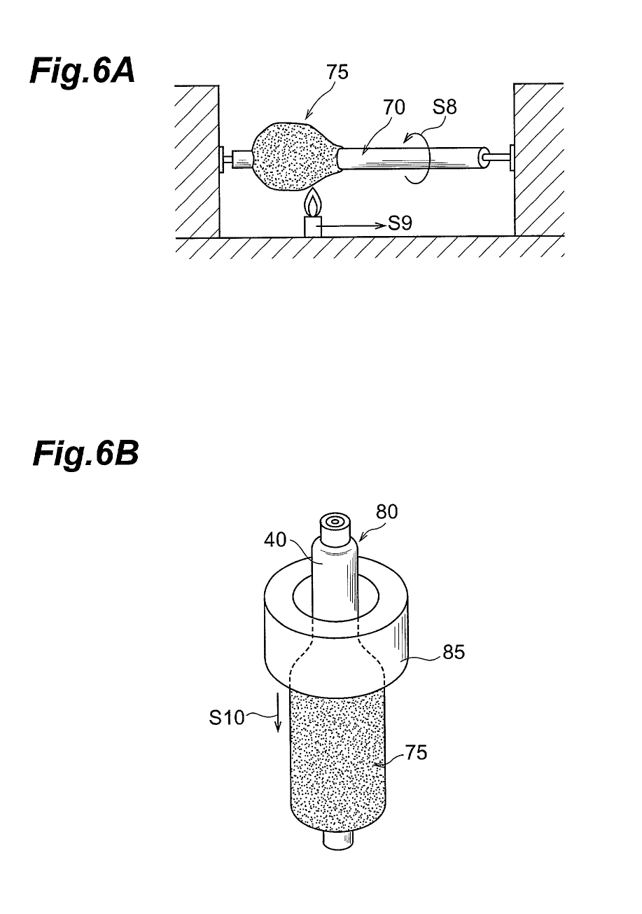

In the earlier stage, as shown in FIG. 6A, a glass-synthesizing flame is moved in the direction indicated by depicted arrow S9 while the second collapsed body 70 is being rotated in the direction indicated by depicted arrow S8, whereby the glass soot body 75 is deposited on the surface of the second collapsed body 70. In this earlier stage, a glass material gas is supplied to the flame together with a fuel gas. Then, as fine glass particles synthesized within the flame moving in the direction indicated by arrow S9 are blown onto the surface of the second collapsed body 70, the porous glass soot body 75 is deposited on the surface of the second collapsed body 70.

In the later stage, the glass soot body 75 containing the second collapsed body 70 obtained by the earlier stage shown in FIG. 6A is sintered by an electric heater 85. As a consequence, the outer periphery of the second collapsed body 70 is provided with a glass material layer 40. Specifically, as shown in FIG. 6B, the electric heater 85 is moved in the direction indicated by depicted arrow S10 while both ends of the glass soot body 75 including the second collapsed body 70 are secured in a state rotatable about its axis, so that the glass soot body 75 is sintered, whereby the glass material layer 40 is obtained.

A preform 80 is obtained by way of the foregoing earlier and later stages.

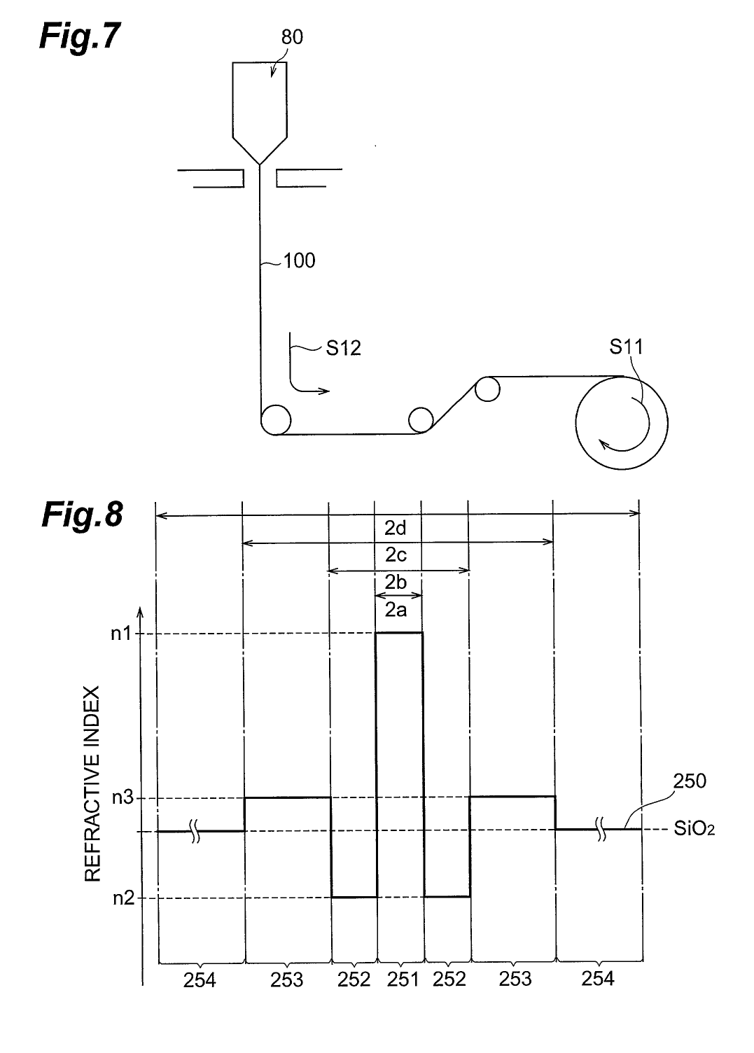

The method of making an optical fiber according to the present invention will now be explained. This method of making an optical fiber includes a drawing step utilizing the preform 80 obtained by way of the foregoing first to third steps. This drawing step is carried out by the drawing apparatus shown in FIG. 7. Specifically, the drawing apparatus shown in FIG. 7 comprises a drum rotating in the direction indicated by depicted arrow S11, and the rotation of this drum acts as a drawing power. While a front end portion of the preform 80 is heated by an electric heater, the drum rotates in the direction indicated by arrow S11, whereby one end of the preform 80 is drawn in the direction indicated by depicted arrow S12. The drawn optical fiber 100 is taken up by the drum rotating in the direction indicated by depicted arrow S11.

The preform 80 in which each member is restrained from deforming is obtained by way of the foregoing first to third steps, and the optical fiber 100 with a less polarization mode dispersion having the cross-sectional structure shown in FIG. 1A and the refractive index profile shown in FIG. 1B is obtained by utilizing this preform 80. Thus obtained optical fiber 100 has a diameter of 100 μm, whereas the outer periphery of the optical fiber 100 is provided with a coating layer having an outer diameter of 150 μm. The ellipticity of the optical fiber obtained by way of the individual steps explained in the foregoing was suppressed low, whereas the polarization mode dispersion of the optical fiber was 0.1 ps·km^{-½}, thus being a favorable value.

For verifying the influence on the change in characteristics of an optical fiber due to the change in ratio of the outer diameter of first cladding tube 20 to the outer diameter of core rod 10, the inventors manufactured a dispersion-compensating fiber, as a comparative example, from a preform in which only the first step was carried out while the outer diameter of the first cladding tube was set 17 times that of the core rod (preform in which the collapsing step was carried out only once in its manufacturing process). As a result, while thus obtained dispersion-compensating fiber yielded a favorable transmission loss value of 2 dB/km, its polarization mode dispersion was 0.4 ps·km^{-½}, thus being an unfavorable value. This is assumed to be because of the fact that deformation occurred upon collapsing since the ratio of the outer diameter of the first cladding tube to that of the core rod in the first collapsing step is too large.

By contrast, the inventors also prepared a dispersion-compensating fiber in which the ratio of the outer diameter of first cladding tube to that of the core rod to be collapsed was set lower, i.e., 3.5, in the first collapsing step, the ratio of the outer diameter of the second cladding tube to that of the first collapsed body to be collapsed in the second collapsing step was set to 6.8, and the collapsing step was carried out twice in the preform manufacturing step, and its optical characteristics were measured. In the second collapsed body obtained by the second collapsing step, the outer diameter of the second collapsed body was 15 times that of the core rod. Also, the surface of the first collapsed body to be collapsed in the second collapsing step was etched by a thickness of 1.4 mm after elongation. As a consequence, thus obtained dispersion-compensating fiber yielded a favorable transmission loss value of 1.4 dB/km, but its polarization mode dispersion was 0.3 ps·km^{-½}, whereby a deterioration caused by deformation was seen.

From the foregoing results of measurement, the outer diameter ratio of the first cladding tube to the core rod in the first collapsing step is preferably 4.5 or more but 6.5 or less.

Without being restricted to the above-mentioned manufacturing steps and configurations, the method of making a preform and the method of making an optical fiber utilizing this preform according to the present invention can be modified in various manners.

In the above-mentioned example, for instance, the second cladding tube 30 and jacket layer 40 are also doped with fluorine (refractive index lowering agent) on a par with the first cladding tube 20. In the refractive index profile of the optical fiber obtained in this case, as shown in FIG. 1B, the individual glass regions 2 to 4 constituting the cladding region 5 have substantially the same refractive index, and the resulting optical fiber yields a positive dispersion slope. The refractive index profile is not restricted to this example, whereas the kind of dopant with respect to each region and the doping amount thereof may appropriately be adjusted according to various characteristics of the dispersion-compensating fiber required, whereby optical fibers having various refractive index profiles such as a double cladding structure and a triple cladding structure can be made.

For example, as shown in FIG. 8, an optical fiber having a depressed cladding structure in which the second cladding 3 has a refractive index higher than that of the first cladding 2 and jacket layer 4 is obtained when the second cladding tube 30 is pure silica glass or chlorine-doped silica glass. The optical fiber obtained in this case yields a negative dispersion slope.

The abscissa of the refractive index profile 250 shown in FIG. 8 corresponds to individual positions along the line L shown in the cross-sectional structure in FIG. 1A on a cross section perpendicular to the center axis of core region 1. The core region 1 has an outer diameter 2a and a refractive index n₁, the first cladding 2 has an outer diameter 2b and a refractive index n₂, the second cladding 3 has an outer diameter 2c and a refractive index n₃, and the jacket layer 4 is pure silica glass having an outer diameter 2d. In this refractive index profile 250, areas 251, 252, 253, and 254 indicate refractive indices on the line L of parts in the core region 1, first cladding 2, second cladding 3, and jacket layer 4, respectively. Here, the core region 1 is doped with a refractive index enhancing agent such as germanium so as to increase the refractive index with reference to the refractive index (indicated by a dotted line in FIG. 1B) of pure silica glass (SiO₂), whereas each of the first cladding 2, second cladding 3, and jacket layer 4 is doped with a refractive index lowering agent such as fluorine.

In the present invention, as in the foregoing, the collapsing step for forming a preform is carried out in a plurality of separate stages, so that the ratio of the outer diameter of the outer member to the outer diameter of the inner member to be collapsed can be reduced, whereby the core and cladding can effectively be restrained from deforming when making the preform. While the ellipticity (deviation from a perfect circle) becomes a cause for increasing the polarization mode dispersion, an optical fiber such as a dispersion-compensating fiber having an excellent polarization mode dispersion characteristic is obtained when the preform yielded by the making method according to the present invention is utilized. The reduction in polarization mode dispersion is important in particular in WDM type optical communications.

When an H₂/O₂ flame, which is excellent in controllability, is used as a heat source in the collapsing step, for example, each member constituting the preform can further be restrained from deforming. While OH-radical intrudes into the outer peripheral portion of the collapsed body at the time of collapsing, the part where OH-radical has intruded is eliminated when the outer peripheral portion is etched with an HF solution in the present invention, whereby an optical fiber excellent in the polarization mode dispersion characteristic, in which the transmission loss is effectively restrained from increasing, is obtained.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of making a preform, said method comprising a first step of forming a first collapsed body, and a second step of forming a second collapsed body by integrally depositing a glass material layer to become a part of a cladding region onto an outer periphery of said first collapsed body with integrated with;
said first step including a first collapsing step in which, in a state where a core rod to become a core region is inserted in a first cladding tube to become a part of said cladding region, said core rod and first cladding tube are integrated by heating, and a first elongating step of elongating said collapsed body obtained by said first collapsing body until a predetermined outer diameter is attained;
said second step including a second collapsing step in which, in a state where said first collapsed body obtained by said first step is inserted in a second cladding tube to become a part of said cladding region, said first collapsed body and second cladding tube are integrated by heating.

2. A method of making a preform according to claim 1, further comprising an etching step performed after said first elongating step, said etching step etching a surface of said elongated collapsed body obtained by said first elongating step.

3. A method of making a preform according to claim 2, wherein an outer peripheral portion of said first collapsed body to be etched in said etching step has a thickness of 1.0 to 2.5 mm.

4. A method of making a preform according to claim 1, wherein said first collapsed body has an OH-radical concentration of 1 ppm or less therewithin.

5. A method of making a preform according to claim 1, wherein said second collapsed body has an OH-radical concentration of 3 ppm or less therewithin.

6. A method of making a preform according to claim 1, wherein said collapsed body obtained by said first collapsing step is elongated in said first elongating step until the outer diameter after elongation becomes ½ or less of that before elongation.

7. A method of making a preform according to claim 1, wherein said collapsed body obtained by said first collapsing step has an outer diameter of 4.5 times or more but 6.5 times or less that of said core rod at the time when said first collapsing step ends.

8. A method of making a preform according to claim 1, wherein said second collapsed body has an outer diameter of 14 times or more that of said core rod at the time when said second collapsing step ends.

9. A method of making a preform according to claim 1, further comprising a second elongating step of elongating said second collapsed body obtained by said second collapsing step until a predetermined outer diameter is attained.

10. A method of making a preform according to claim 1, further comprising a glass depositing step of depositing a glass soot body on an outer peripheral surface of said second collapsed body, and sintering said glass soot body so as to form a glass material layer to become a jacket layer.

11. A method of making a preform according to claim 1, wherein each of said first and second collapsing steps is carried out by using one of an electric heater and a flame, said flame being obtained by burning one of O₂ and air with a hydrogen fuel, or burning one of O₂ and air with a hydrocarbon fuel.

12. A method of making a preform according to claim 1, wherein said first cladding tube includes silica glass doped with a predetermined amount of fluorine.

13. A method of making a preform according to claim 12, wherein said second cladding tube includes silica glass doped with a predetermined amount of fluorine.

14. A method of making a preform according to claim 12, wherein said second cladding tube includes one of pure silica glass and silica glass doped with a predetermined amount of chlorine.

15. A method of making an optical fiber comprising the steps of:
preparing the preform according to claim 10; and
drawing said preform while heating a part of said preform prepared.
